(19) United States
(12) Patent Application Publication
(10) Pub. No.: US 2024/0413792 A1
(43) Pub. Date: Dec. 12, 2024

(54) PHOTOVOLTAIC COMPONENT

(71) Applicants: JINKO SOLAR (HAINING) CO., LTD., HAINING (CN); JINKO SOLAR CO., LTD., SHANGRAO (CN)

(72) Inventors: Sen YANG, Haining (CN); Boyang WANG, Haining (CN); Bo LI, Haining (CN); Tong YU, Haining (CN); Hanxu TIAN, Haining (CN); Yi CHENG, Haining (CN); Fei YANG, Haining (CN)

(21) Appl. No.: 18/735,211

(22) Filed: Jun. 6, 2024

(30) Foreign Application Priority Data
Jun. 9, 2023 (CN) 202310684303.9
Jun. 9, 2023 (CN) 202310686821.4
Jun. 9, 2023 (CN) 202310688421.7
Jun. 9, 2023 (CN) 202321475513.9
Jun. 9, 2023 (CN) 202321476991.1

(51) Int. Cl. H02S 40/36

(52) U.S. Cl. CPC H02S 40/36

(57) ABSTRACT

A photovoltaic component, including a plurality of color steel tiles and a plurality of photovoltaic modules. Cavities are formed between the photovoltaic modules and the color steel tiles. The photovoltaic component further includes cables connecting two adjacent photovoltaic modules. The cables are provided with fixing portions. The fixing portions are configured to fix the cables to a side of the photovoltaic modules close to the color steel tiles. The cables are located in the cavities. Along a thickness direction of the photovoltaic modules, the cables and the color steel tiles are not in contact with each other.

### CROSS-REFERENCE TO RELATED APPLICATIONS

The present application claims priority to Chinese Patent Applications No. 202310688421.7, No. 202321476991.1, No. 202310684303.9, No. 202321475513.9, No. 202310686821.4, all filed on Jun. 9, 2023, the contents of which are incorporated herein by reference in their entireties.

### TECHNICAL FIELD

The present disclosure relates to the technical field of photovoltaics, and in particular, to a photovoltaic component.

### BACKGROUND

A photovoltaic component is a device that can convert solar energy into electrical energy, which may be mounted on a roof of a building. The photovoltaic component includes photovoltaic panels for photoelectric conversion and color steel tiles for support and mounting. In order to achieve higher power generation, the photovoltaic component generally includes a plurality of photovoltaic panels connected to each other via cables. Since the operating environment of the photovoltaic component is generally outdoor, it is easy to accumulate water in the color steel tiles due to rain and snow, causing the cables to be soaked in the water. As a result, the cables may be damaged or even short-circuited, which significantly shortens the service life of the photovoltaic module.

### SUMMARY

The present disclosure provides a photovoltaic component to solve the problems of easy damages to cables of the photovoltaic component and short service life.

The present disclosure provides a photovoltaic component, including: a plurality of color steel tiles, adjacent color steel tiles of the plurality of color steel tiles are connected to each other along a width direction of the photovoltaic component; a plurality of photovoltaic modules mounted, along a thickness direction of the photovoltaic component, to a side of the color steel tiles, a plurality of cavities are formed between the photovoltaic modules and the color steel tiles; and cables each connecting to two adjacent photovoltaic modules, each of the cables is provided with at least one fixing portion configured to fix the cable to a side of the photovoltaic module close to a corresponding one of the color steel tiles, the cables are located in the cavities, and along the thickness direction, the cables and the color steel tiles are not in contact with each other.

In some embodiments, a distance between the cable and the color steel tile in the thickness direction is H, where 0<H≤200 mm.

In some embodiments, a gap is formed between adjacent photovoltaic modules, and a width of the gap is L1, where 0<L1≤200 mm.

In some embodiments, each of the cables comprises a positive cable and a negative cable which are connected to each other through a joint, one of two adjacent photovoltaic modules is connected with the positive cable, the other one of the two adjacent photovoltaic modules is connected with the negative cable, at least one of the positive cable and the negative cable is fixed to the side of the photovoltaic module close to the color steel tile through the fixing portion, and along the thickness direction of the photovoltaic component, a projection of the joint does not overlap with the gap.

In some embodiments, a distance between the fixing portion and the joint is L2, where 0<L2≤200 mm.

In some embodiments, when a plurality of fixing portions are provided, a distance between two adjacent fixing portions is L3, and L3≤300 mm.

In some embodiments, the color steel tiles each include at least one reinforcing portion, the reinforcing portion protrudes towards the photovoltaic module, the cable extends along a length direction of the photovoltaic module, and in the thickness direction of the photovoltaic component, a projection of the cable does not overlap with the reinforcing portion.

In some embodiments, the photovoltaic modules each include a main body portion, the fixing portion comprises a first fixing member arranged on the main body portion, the main body portion includes a first side and a second side arranged opposite to each other along a length direction of the main body portion and a third side and a fourth side arranged opposite to each other along a width direction of the main body portion, along the length direction of the main body portion, a distance between a mounting point of the first fixing member and the first side or the second side is L4, where 0 mm≤L4≤1000 mm, and along the width direction of the main body portion, a distance between the mounting point of the first fixing member and the third side or the fourth side is L5, where 0 mm≤L5≤350 mm.

In some embodiments, the main body portion includes a port, the cable is connected to the main body portion through the port, and the first fixing member is configured to fix an end of the cable away from the port; and the photovoltaic module further includes a second fixing member, along an extension direction of the cable, the second fixing member is located between the port and the first fixing member and is configured to fix the cable.

In some embodiments, the photovoltaic module includes a plurality of second fixing members, and the second fixing members are distributed at intervals along the extension direction of the cable.

In some embodiments, a distance between the port and a mounting point of the second fixing portion adjacent to the port is b, where 0 mm≤b≤100 mm.

In some embodiments, a distance between mounting points of adjacent second fixing members is c, where 0 mm≤c≤100 mm.

In some embodiments, the cable includes a first cable and a second cable, the first cable of each of the photovoltaic modules is configured to be electrically connected to the second cable of another one of the photovoltaic modules, and at least one of the first cable and the second cable connected to each other includes a bending section.

In some embodiments, a length direction of the color steel tiles is defined as a first direction, and a width direction of the color steel tiles is defined as a second direction; a plurality of photovoltaic modules sequentially are arranged along the first direction over the color steel tiles, the photovoltaic modules includes first photovoltaic modules arranged at two outermost ends, and second photovoltaic modules arranged in the middle; at least part of the first photovoltaic modules are connected to at least another one of the first photovoltaic modules on one side along the second direction; and the second photovoltaic modules are connected to the first photovoltaic modules on at least one side along the first direction.

In some embodiments, along the second direction, two adjacent first photovoltaic modules are connected to each other, and the two first photovoltaic modules are respectively connected to adjacent second photovoltaic modules along the first direction to form a first series-connection structure.

In some embodiments, a same end of the color steel tile is provided with a plurality of first series-connection structures, and the plurality of first series-connection structures are sequentially arranged adjacent to each other along the second direction.

In some embodiments, two ends of the color steel tile are each provided with a plurality of first series-connection structures, and the first series-connection structures at the two ends are arranged in a staggered manner.

In some embodiments, two ends of the first series-connection structure are respectively connected to another one of the first photovoltaic modules along the first direction.

In some embodiments, along the second direction, two of the first photovoltaic modules spaced apart from each other are connected to each other, and the two first photovoltaic modules are respectively connected to adjacent second photovoltaic modules along the first direction.

In some embodiments, along the second direction, adjacent first photovoltaic modules are sequentially connected to each other, and the two first photovoltaic modules at the two outermost ends are respectively connected to adjacent second photovoltaic modules along the first direction; or along the second direction, one of the first photovoltaic modules is connected to another one of the first photovoltaic modules through a first cable, and the first cable bypasses an end of the color steel tile along the first direction.

### BRIEF DESCRIPTION OF DRAWINGS

FIG. 1 is a schematic structural diagram of a photovoltaic component according to some embodiments of the present disclosure;

FIG. 2 is a schematic diagram of a partial structure of a photovoltaic component according to some embodiments of the present disclosure;

FIG. 3 is a schematic position diagram of a fixing portion according to some embodiments of the present disclosure;

FIG. 4 is a schematic position diagram of the fixing portion according to some embodiments of the present disclosure;

FIG. 5 is a schematic position diagram of the fixing portion according to some embodiments of the present disclosure;

FIG. 6 is a schematic structural diagram of the fixing portion according to some embodiments of the present disclosure;

FIG. 7 is a schematic structural diagram of the fixing portion according to some embodiments of the present disclosure;

FIG. 8 is a schematic structural diagram of the fixing portion according to some embodiments of the present disclosure;

FIG. 9 is a schematic diagram of a photovoltaic module according to some embodiments of the present disclosure;

FIG. 10 is a partial schematic diagram of connections between photovoltaic modules according to the present disclosure;

FIG. 11 is a schematic diagram of connections between the photovoltaic modules according to some embodiments of the present disclosure;

FIG. 12 is a schematic diagram of connections between the photovoltaic modules according to some other embodiments of the present disclosure;

FIG. 13 is a schematic diagram of connections between the photovoltaic modules according to some other embodiments of the present disclosure;

FIG. 14 is a schematic diagram of connections between the photovoltaic modules according to some other embodiments of the present disclosure;

FIG. 15 is a partial schematic diagram of the photovoltaic component according to some embodiments of the present disclosure;

FIG. 16 is a schematic diagram of a partial structure of the photovoltaic component according to some embodiments of the present disclosure;

FIG. 17 is a schematic structural diagram of a photovoltaic component according to some embodiments of the present disclosure;

FIG. 18 is a schematic diagram of a first connection manner of the photovoltaic component according to some embodiments of the present disclosure;

FIG. 19 is a schematic diagram of a second connection manner of the photovoltaic component according to some embodiments of the present disclosure;

FIG. 20 is a schematic diagram of a third connection manner of the photovoltaic component according to some embodiments of the present disclosure;

FIG. 21 is a schematic diagram of a fourth connection manner of the photovoltaic component according to some embodiments of the present disclosure;

FIG. 22 is a schematic diagram of a fifth connection manner of the photovoltaic component according to some embodiments of the present disclosure;

FIG. 23 is a schematic diagram of a sixth connection manner of the photovoltaic component according to some embodiments of the present disclosure;

FIG. 24 is a projection view of a photovoltaic component along a first direction according to some embodiments of the present disclosure;

FIG. 25 is a schematic diagram of a first arrangement manner of photovoltaic modules according to some embodiments of the present disclosure;

FIG. 26 is a schematic diagram of a second arrangement manner of the photovoltaic modules according to some embodiments of the present disclosure;

FIG. 27 is a schematic diagram of a third arrangement manner of the photovoltaic modules according to some embodiments of the present disclosure; and

FIG. 28 is a schematic diagram of a fourth arrangement manner of the photovoltaic modules according to some embodiments of the present disclosure.

### DESCRIPTION OF EMBODIMENTS

In order to better understand the technical solution of the present disclosure, embodiments of the present disclosure are described in detail below with reference to the accompanying drawings.

It should be clear that the embodiments described are only some rather than all of the embodiments of the present disclosure. All other embodiments acquired by those of ordinary skill in the art without creative efforts based on the embodiments of the present disclosure fall within the protection scope of the present disclosure.

The terms used in the embodiments of the present disclosure are intended solely to describe particular embodiments and are not intended to limit the present disclosure. As used in the specification of the present disclosure and the appended claims, the singular forms of “a/an”, “said”, and “the” are intended to include plural forms, unless otherwise clearly specified in the context.

It should be understood that the term “and/or” used herein only describes an association relationship between associated objects and represents that three relationships may exist. For example, A and/or B may represent the following three cases: only A exists, both A and B exist, and only B exists. In addition, the character “/” herein generally means that associated objects before and after it are in an “or” relationship.

It is to be noted that terms indicating orientations such as “up”, “down”, “left”, and “right” described in embodiments of the present disclosure are described from the perspective shown in the drawings and should not be understood as limitations to the embodiments of the present disclosure. In addition, it is to be further understood that, depending on the context, one element described as being connected “on/above” or “under/below” another element not only means that the element may be directly connected “on/above” or “under/below” the another element, but also means that the element may be indirectly connected “on/above” or “under/below” the another element through an intermediate element.

Building integrated photovoltaic (BIPV) is a technology that integrates photovoltaic power generation products into buildings, in which solar panels are designed into a variety of building decoration materials to replace traditional decoration materials such as glass curtain walls or roof tiles. For example, photovoltaic tile roofs may protect the building against wind and rain, and can also be used as solar power generation systems to provide environmentally friendly electricity. Photovoltaic tiles are an important part of a rooftop power station, which are configured to convert received solar energy into electrical energy and may meet electrical energy needed in daily production and life.

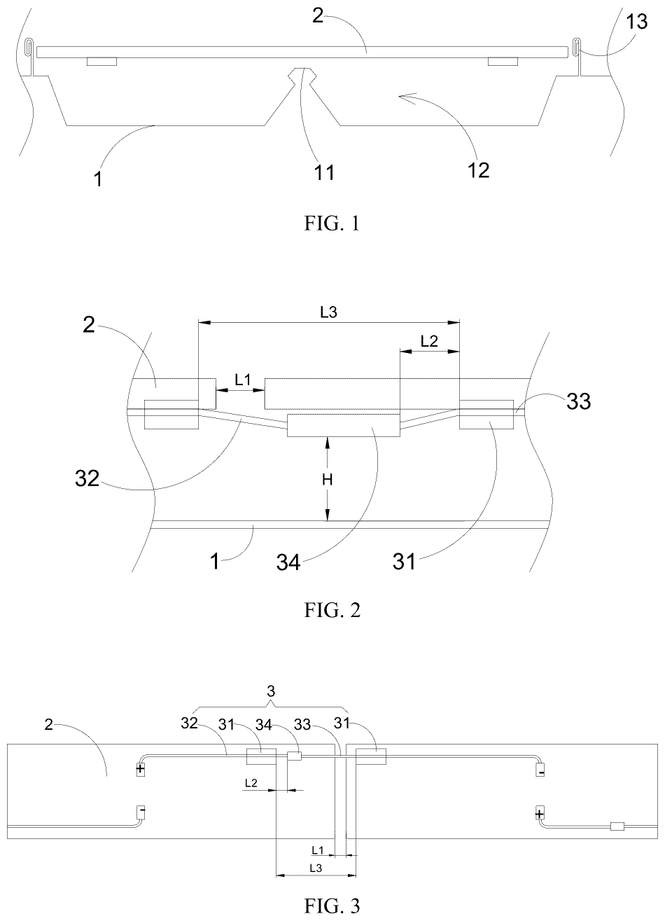

As shown in FIG. 1 and FIG. 2, some embodiments of the present disclosure provide a photovoltaic component. The photovoltaic component includes a plurality of color steel tiles 1 and a plurality of photovoltaic modules 2. Adjacent color steel tiles 1 are connected to each other along a width direction thereof. The photovoltaic modules 2 are mounted to sides of the color steel tiles 1 along a thickness direction of the photovoltaic component. Cavities 12 are formed between the photovoltaic modules 2 and the color steel tiles 1. A cable 3 connects two adjacent photovoltaic modules 2. The cables 3 are provided with fixing portions 31. The fixing portions 31 are configured to fix the cables 3 to sides of the photovoltaic modules 2 close to the color steel tiles 1. The cables 3 are located in the cavities 12. Along a thickness direction of the photovoltaic module 2, the cable 3 and the color steel tile 1 are not in contact with each other.

The photovoltaic component includes the color steel tiles 1 and the photovoltaic modules 2. The color steel tiles 1 are located at the bottom of the photovoltaic modules 2. The color steel tiles 1 mainly support the photovoltaic modules 2. The photovoltaic modules can convert solar energy into electrical energy to generate electricity. The plurality of photovoltaic modules 2 are connected to each other through the cables 3 to collect and transmit currents. Since the photovoltaic component is required to receive sunlight, an operating environment thereof is generally outdoors. For example, the photovoltaic component is mounted on a roof, so the photovoltaic component may be affected by an outdoor environment. In particular, the cables 3 are easily damaged due to environmental factors. For example, in rainy and snowy weather, it is easy to accumulate water between the color steel tiles 1 and the photovoltaic modules 2, and if the cables 3 are in contact with the water or soaked in the water for a long time, the cable 3 may be short-circuited or damaged, causing failure of electrical connections between the photovoltaic component, affecting overall power generation efficiency of the photovoltaic component, and even causing damages to the photovoltaic component. According to the photovoltaic component provided in some embodiments of the present disclosure, for the cables 3, the cables 3 are fixed to sides of the photovoltaic modules 2 close to the color steel tiles 1 through the fixing portions 31, the cables 3 are in contact with the photovoltaic modules 2 or in a suspended state, and the cables 3 will not come into contact with the color steel tiles 1. In this way, even if there is water accumulation in the color steel tiles 1, the cables 3 may not come into contact with the water, which can reduce the possibility of damages to the cables 3 and prolong the service life of the photovoltaic component.

As shown in FIG. 1, in some embodiments, the color steel tiles 1 are provided with reinforcing portions 11, and the reinforcing portions 11 protrude along a direction close to the photovoltaic modules 2.

The reinforcing portions 11 protrude along the thickness direction of the photovoltaic component. When the photovoltaic modules 2 are subjected to an external force, the photovoltaic modules 2 may deform along a direction close to the color steel tiles 1. The reinforcing portions 11 can support the photovoltaic modules 2, reducing the possibility of damages to the photovoltaic modules 2. The cavities 12 are formed between the photovoltaic modules 2 and the color steel tiles 1. Along a width direction of the photovoltaic component, the cavities 12 are located on two sides of the reinforcing portions 11 respectively. The cavities 12 extend along the length direction of the photovoltaic component. The cables 3 are located inside the cavities 12, and the cables 3 extend inside the cavities 12 along the length direction of the photovoltaic component. The cables 3 do not cross the reinforcing portions 11, which prevents damages due to extrusion of the cables 3 by the reinforcing portions 11 and the photovoltaic modules 2, and prolongs the service life of the cables 3.

Along the width direction of the photovoltaic component, two sides of the color steel tiles 1 are also respectively provided with bending portions 13, and the bending portions 13 of two adjacent color steel tiles 1 can connect the two adjacent color steel tiles 1 to each other by means of their shape.

As shown in FIG. 2, in some embodiments, the cables 3 extend along length directions of the photovoltaic modules 2, and along the thickness direction of the photovoltaic component, projections of the cables 3 and the reinforcing portions 11 do not overlap.

The reinforcing portions 11 protrude towards the photovoltaic component along the thickness direction of the photovoltaic component, and the cables 3 do not cross the reinforcing portions 11, which prevents the cables 3 from being pressed flat or damaged to by the reinforcing portions 11 and the photovoltaic modules 2 due to abutment of the reinforcing portions 11 against the cables 3. The photovoltaic modules 2 tend to move close to the color steel tiles 1 under gravity, and when mounting and maintaining the photovoltaic component, an operator may stand directly on the photovoltaic component and the photovoltaic modules 2 may move close to the color steel tiles 1 under an external force. If the cables 3 are arranged across the reinforcing portions 11, when the photovoltaic modules 2 move close to the color steel tiles 1 under an external force, distances between the photovoltaic modules 2 and the reinforcing portions 11 may decrease. If the distances between the photovoltaic modules 2 and the reinforcing portions 11 are less than diameters of the cables 3, the cables 3 may be compressed, affecting normal operation of the photovoltaic component and even causing damages to the photovoltaic component.

As shown in FIG. 2, in some embodiments, distances between the cables 3 and the color steel tiles 1 in the thickness directions of the photovoltaic modules 2 are H, where 0<H≤200 mm.

In some embodiments of the present disclosure, distances between the photovoltaic modules 2 and the color steel tiles 1 are given, so that the color steel tiles 1 stably support the photovoltaic modules 2, and sufficient spaces are provided between the photovoltaic modules 2 and the color steel tiles 1 to form the cavities 12 to facilitate the arrangement of the cables 3.

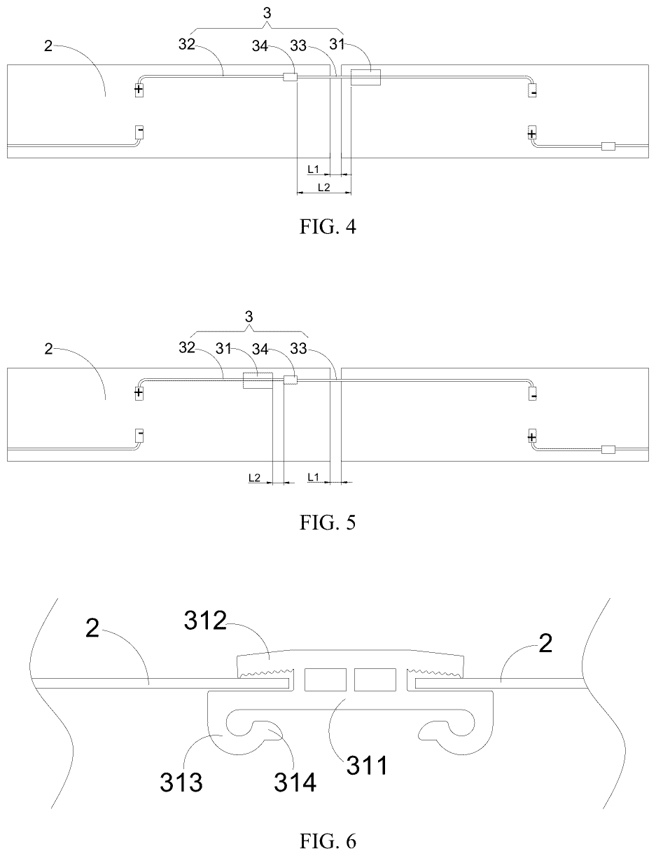

As shown in FIG. 3 to FIG. 5, in some embodiments, a gap is provided between adjacent photovoltaic modules 2, and a width of the gap is L1, where 0<L1≤200 mm.

The adjacent photovoltaic modules 2 may be fixedly connected to each other through clamps 4. The clamps 4 are sequentially arranged along the length direction of the photovoltaic component. In some embodiments of the present disclosure, specific width sizes of the gaps are given, so that smaller gaps can reduce entry of rain and snow into the color steel tiles 1 through the gaps, and on the other hand, difficulty of arrangement and mounting of the photovoltaic modules 2 is taken into account.

As shown in FIG. 2, in some embodiments, the cables 3 each include a positive cable 32 and a negative cable 33 which are connected to each other through a joint 34. One of two adjacent photovoltaic modules 2 is provided with the positive cable 32, the other is provided with the negative cable 33. At least one of the positive cables 32 and the negative cables 33 is fixed to the sides of the photovoltaic modules 2 close to the color steel tiles 1 through the fixing portions 31, and along the thickness direction of the photovoltaic component, projections of the joints 34 and the gaps do not overlap.

The photovoltaic component includes a plurality of color steel tiles 1. The plurality of color steel tiles 1 are distributed along length directions and width directions thereof. One color steel tile 1 is provided with a plurality of photovoltaic modules 2 at intervals. The photovoltaic modules 2 are provided with photovoltaic panels. The photovoltaic panels can convert solar energy into electrical energy. The positive cable 32 and the negative cable 33 are configured to connect two adjacent photovoltaic modules 2. The positive cable 32 and the negative cable 33 are connected to each other through joints 34. The joints 34 are located at the bottom of the photovoltaic modules 2, which avoid the gaps between two adjacent photovoltaic modules 2, thereby reducing the possibility of influences of rain and snow on the photovoltaic modules 2. The fixing portion 31 is configured to fix the cable 3. For example, the fixing portion 31 may fix one of the positive cable 32 and the negative cable 33, that is, located on one side of the joint 34. Alternatively, the photovoltaic component is provided with a plurality of fixing portions 31. The fixing portions 31 are fixed to the positive cable 32 and the negative cable 33 respectively, that is, located on two sides of the joint 34 respectively.

As shown in FIG. 3 to FIG. 5, in some embodiments, a distance between the fixing portion 31 and the joint 34 is L2, where 0<L2≤200 mm.

In some embodiments of the present disclosure, the distance between the fixing portion 31 and the joint 34 is given, so as to control a drooping distance of the cable 3, so that the cable 3 may not come into contact with the color steel tile 1. The arrangement position of the fixing portion 31 affects the drooping distance of the cable 3. If the fixing portion 31 is too far away from the joint 34, the side of the cable 3 away from the fixing portion 31 may droop, thereby being easily come into contact with the color steel tile 1 and thus affected by rain, snow, and water.

As shown in FIG. 3, in some embodiments, when the photovoltaic component includes a plurality of fixing portions 31, a distance between two adjacent fixing portions 31 is L3, where L3≤300 mm.

The two adjacent fixing portions 31 are spaced apart from each other to facilitate the entire cable 3 to move close to the photovoltaic module 2. With the setting of an appropriate spacing distance between two adjacent fixing portions 31, an overall drooping distance of the cable 3 can be reduced, so that the cable 3 is kept as far away from the color steel tile 1 as possible to reduce the influences of rain, snow, and water falling on the color steel tile 1 to the cable 3.

In some embodiments, the fixing portion 31 has one part bonded to the photovoltaic module 2 and the other part bonded to the cable 3.

The fixing portion 31 may connect the photovoltaic module 2 and the cable 3 by bonding. For example, the fixing portion 31 has one part bonded to a side of the photovoltaic module 2 close to the color steel tile 1 and the other part bonded to the cable 3, thereby connecting the photovoltaic module 2 and the cable 3 and realizing fixation of the cable 3. For example, the fixing portion 31 may be an adhesive.

In some embodiments, the fixing portion 31 has one part engaging with or bonded to the photovoltaic module 2 and the other part engaging with the cable 3.

The fixing portion 31 may alternatively be connected to the photovoltaic module 2 by engagement. The fixing portion 31 is provided with a recess for engagement, so as to engage with an edge of the photovoltaic module 2. For example, the gap provided between two adjacent photovoltaic modules 2 engages with the photovoltaic modules 2. Two sides of the same fixing portion 31 may each be provided with a recess, which can engage with two adjacent photovoltaic modules 2. The other part of the photovoltaic module 2 may be provided with a hook or a bonding region to be connected to the cable 3, thereby fixing the cable 3. For example, the fixing portion 31 may be a silicone clip.

As shown in FIG. 6, in some embodiments, the fixing portion 31 includes a body portion 311, and two opposite sides of the body portion 311 are each provided with a clamping portion 312. The clamping portion 312 and the body portion 311 are respectively located on two sides of the photovoltaic module 2 to clamp the photovoltaic module 2. The two clamping portions 312 respectively fit the body portion 311 to clamp two adjacent photovoltaic modules 2, thereby realizing connection and fixation of the photovoltaic module 2. The bottom of the fixing portion 31 is provided with an engaging portion 313. An accommodating space is formed between the engaging portion 313 and the clamping portion 312. The accommodating space is used to accommodate the cable 3. A side of the engaging portion 313 close to the accommodating space is provided with a guide end 314. The guide end 314 is in the shape of an arc, which facilitates the cable 3 to extend into the accommodating space to be engaged with the engaging portion 313. The two engaging portions 313 are respectively arranged on two opposite sides of the fixing portion 31, which can realize fixation of two cables 3.

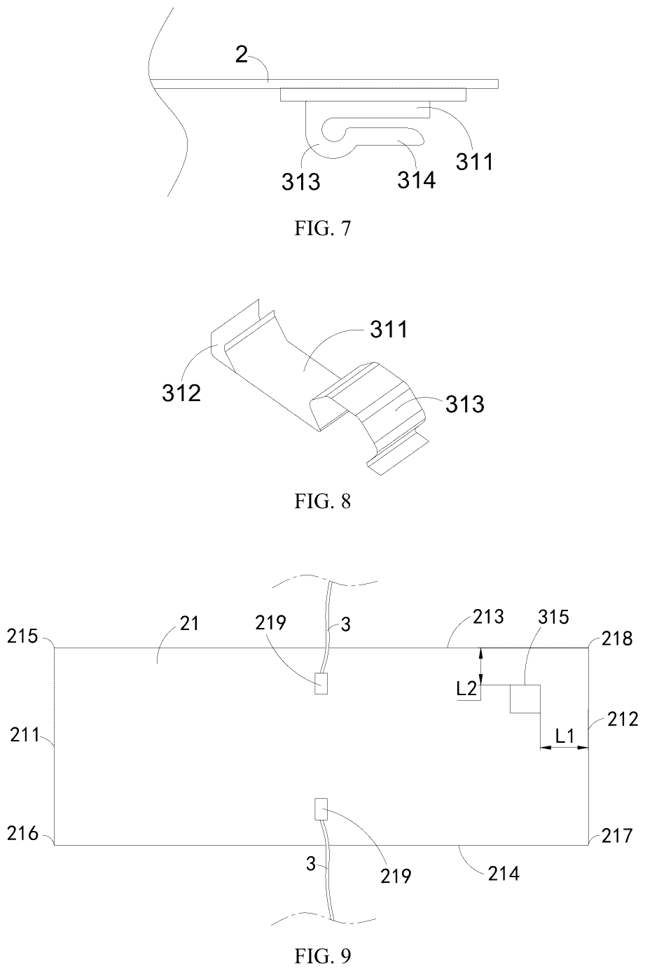

As shown in FIG. 7, in some embodiments, the fixing portion 31 includes a body portion 311. One side of the body portion 311 and the photovoltaic module 2 are connected to each other by silicone bonding. A side of the body portion 311 away from the photovoltaic module 2 is provided with an engaging portion 313. An accommodating space is formed between the engaging portion 313 and the body portion 311. The accommodating space is used to arrange the cable 3. An end of the engaging portion 313 not connected to the body portion 311 is provided with a guide end 314. The guide end 314 extends along an arrangement direction of the photovoltaic module 2 and is configured to guide the cable 3 during engagement, so as to facilitate the cable 3 to enter the accommodating space.

As shown in FIG. 8, in some embodiments, the fixing portion 31 includes a body portion 311. Two sides of the body portion 311 along the thickness direction of the photovoltaic component are provided with a first clamping portion 312 and a second clamping portion 312 respectively. The first clamping portion 312 and the second clamping portion 312 open towards opposite directions. The first clamping portion 312 is configured to clamp and fix the cable 3. The second clamping portion 312 is configured to fit the engaging portion 313 to suspend and fix the entire fixing portion 31, so that the cable 3 will not contact the bottom of the color steel tile 1.

Some embodiments of the present disclosure provide a photovoltaic component. The photovoltaic component includes a plurality of color steel tiles 1 and a plurality of photovoltaic modules 2. Cavities 12 are provided between the photovoltaic modules 2 and the color steel tiles 1. Cables 3 connect two adjacent photovoltaic modules 2. The cables 3 are provided with fixing portions 31. The fixing portions 31 are configured to fix the cables 3 to sides of the photovoltaic modules 2 close to the color steel tiles 1. The cables 3 are located in the cavities 12. Along thickness directions of the photovoltaic modules 2, the cables 3 and the color steel tiles 1 are not in contact with each other. Therefore, the possibility of damages to the cables 3 is reduced, and the service life of the photovoltaic component is prolonged.

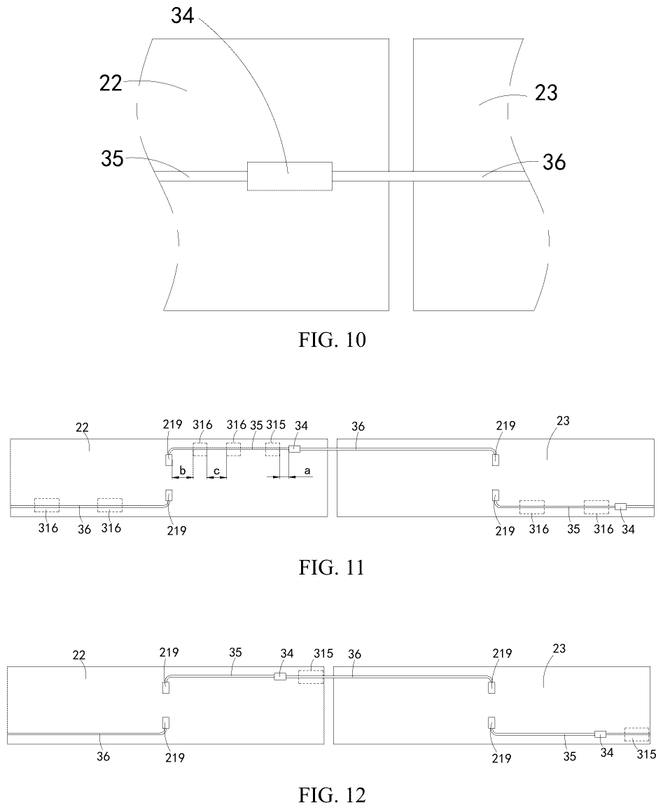

As shown in FIG. 9, some embodiments of the present disclosure provide a photovoltaic module 2. The photovoltaic module 2 includes a main body portion 21 and a cable 3. The main body portion 21 may be a photovoltaic panel, which is configured to absorb light and convert solar energy into electrical energy. The cable 3 is configured to connect adjacent photovoltaic modules 2, so that the adjacent photovoltaic modules 2 can be electrically connected. The photovoltaic module 2 further includes a first fixing member 315. The first fixing member 315 is arranged on the main body portion 21 and configured to fix the cable 3. The main body portion 21 includes a first side 211 and a second side 212 arranged opposite to each other along a length direction thereof and a third side 213 and a fourth side 214 arranged opposite to each other along a width direction thereof. Along the length direction of the main body portion 21, a distance between a mounting point of the first fixing member 315 and the first side 211 or the second side 212 is L4, where 0 mm≤L4≤1000 mm. Along the width direction of the main body portion 21, a distance between the mounting point of the first fixing member 315 and the third side 213 or the fourth side 214 is L5, where 0 mm≤L5≤350 mm.

Generally, the photovoltaic module 2 is mounted on the color steel tile 1, and the cable 3 is located on a side of the photovoltaic module 2 facing the color steel tile 1. The first fixing member 315 may be a member such as a clip. The distance between the mounting point of the first fixing member 315 and the first side 211 or the second side 212 may be 0 mm, 50 mm, 100 mm, 150 mm, 200 mm, 250 mm, 300 mm, 350 mm, 400 mm, 450 mm, 500 mm, 550 mm, 600 mm, 650 mm, 700 mm, 750 mm, 800 mm, 850 mm, 900 mm, 950 mm, 1000 mm, or the like. The distance between the mounting point of the first fixing member 315 and the third side 213 or the fourth side 214 may be 0 mm, 25 mm, 50 mm, 75 mm, 100 mm, 125 mm, 150 mm, 175 mm, 200 mm, 225 mm, 250 mm, 275 mm, 300 mm, 325 mm, 350 mm, or the like. The distances from the mounting point of the first fixing member 315 to the first side 211, the second side 212, the third side 213, or the fourth side 214 may be selected according to an actual situation. In the selection of the above distances, reference may be made to information such as the size of the photovoltaic module 2, the length of the cable 3, and the spacing between adjacent photovoltaic modules 2.

Through the mounting of the first fixing member 315 on the main body portion 21, the cable 3 can be relatively fixedly arranged on the photovoltaic module 2, so that at least part of the cable 3 can be close to a surface of the photovoltaic module 2, thereby reducing the possibility of drooping of the cable 3 down on the color steel tile 1, reducing the possibility of soaking of the cable 3 of the photovoltaic module 2 in water when there is water in the color steel tile 1, and thus reducing the possibility of electrical connection failure, short circuit, and the like in the photovoltaic module 2, which can reduce the possibility of failure of the photovoltaic module 2 and can also reduce potential safety hazards, improve safety, and be more in line with actual usage requirements.

Moreover, through the arrangement of the first fixing member 315, stability of mounting of the cable 3 can be improved, and the possibility of shaking of the cable 3 during the mounting can be reduced.

As shown in FIG. 10 and FIG. 11, in some embodiments, the photovoltaic module 2 includes a connecting member, and the cables of adjacent photovoltaic modules 2 are electrically connected through the connecting member. Along an extension direction of the cable 3, a distance between the mounting point of the first fixing member 315 and the connecting member is a, where 0 mm≤a≤100 mm.

The connecting member may be implemented as the joint 34. The cables 3 of adjacent photovoltaic modules 2 can be electrically connected through the connecting member. The cables 3 and the connecting member are connected by, but not limited to, plugging. The distance between the mounting point of the first fixing member 315 and the connecting member may be 0 mm, 5 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, 100 mm, or the like. The distance between the mounting point of the first fixing member 315 and the connecting member is preferably 0.5 mm to 15 mm.

An end of the cable 3 away from the main body portion 21 is electrically connected to the cable 3 of another photovoltaic module 2 through the connecting member. Through the arrangement of the first fixing member 315 at a position close to the connecting member, the possibility of drooping the connecting member down on the color steel tile 1 can be reduced, thereby reducing the possibility of soaking of the connecting member and the cable 3 connected thereto in the water of the color steel tile 1 and thus reducing potential safety hazards and the possibility of electrical connection failure of the photovoltaic module 2.

Through the arrangement of the first fixing member 315, the possibility of shaking of the cable 3 during the mounting can be reduced, thereby reducing the possibility of shaking of the connecting member.

As shown in FIG. 11, in some embodiments, in projections along the thickness direction of the photovoltaic module 2, the projection of the connecting member is located within the projection range of the main body portion 21.

Through such a design, the connecting member can be arranged on a side of the main body portion 21 facing the color steel tile 1. The main body portion 21 may be configured to shield the connecting member, thereby protecting the connecting member, which can reduce influences of factors such as sunlight, rain, and snow on the service life of the connecting member, and is more in line with actual usage requirements.

As shown in FIG. 11, in some embodiments, the main body portion 21 is provided with a port 219, and the cable 3 is connected to the main body portion 21 through the port 219. The first fixing member 315 is configured to fix an end of the cable 3 away from the port 219. The photovoltaic module 2 may further include a second fixing member 316, and along the extension direction of the cable 3, the second fixing member 316 is located between the port 219 and the first fixing member 315 and configured to fix the cable 3.

The second fixing member 316 may be a member such as a clip. The cable 3 has one end connected to the main body portion 21 through an interface and the other end configured to be electrically connected to the cable 3 of another photovoltaic module 2 through the connecting member. Through the arrangement of the second fixing member 316 between the port 219 and the first fixing member 315, a middle part of the cable 3 can be fixed, thereby reducing the possibility of drooping of the middle part of the cable 3 down on the color steel tile 1 due to gravity and further reducing the possibility of electrical connection failure, short circuit, and the like due to soaking of the cable 3 in the water.

As shown in FIG. 11, in some embodiments, the photovoltaic module 2 includes a plurality of second fixing members 316, and the second fixing members 316 are distributed at intervals along the extension direction of the cable 3.

This design can improve stability of the cable 3 and reduce the possibility of fall-off of the cable 3 from the second fixing members 316 and drooping down to the color steel tile 1.

As shown in FIG. 11, in some embodiments, a distance between the port 219 and a mounting point of the second fixing portion 31 adjacent to the port 219 is b, where 0 mm≤b≤100 mm.

The distance between the second fixing portion 31 closest to the port 219 and the port 219 may be 0 mm, 5 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, 100 mm, or the like. The distance between the port 219 and the mounting point of the second fixing portion 31 adjacent to the port 219 is preferably greater than 10 mm.

Through such a design, stability of fixation of the cable 3 can be further improved, thereby reducing the possibility of drooping of the cable 3 down to the color steel tile 1. The distance between the port 219 and the second fixing portion 31 may be selected according to an actual requirement. In the selection of the above distance, reference may be made to information such as the size of the photovoltaic module 2, the length of the cable 3, and the number of the second fixing member 316.

As shown in FIG. 11, in some embodiments, a distance between mounting points of adjacent second fixing members 316 is c, where 0 mm≤c≤100 mm.

The distance between the mounting points of the adjacent second fixing members 316 may be 0 mm, 5 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, 100 mm, or the like.

When the photovoltaic module 2 includes a plurality of second fixing members 316, the second fixing members 316 may be equally or unequally distributed, which may be arranged according to an actual situation. Through such a design, stability of fixation of the cable 3 by the second fixing members 316 can be improved, thereby reducing the possibility of drooping of the cable 3 down to the color steel tile 1.

In some embodiments, a distance between the second fixing member 316 and the first fixing member 315 may be the same as the distance between adjacent second fixing members 316. That is, the distance between the second fixing member 316 and the first fixing member 315 may range from 0 mm to 100 mm.

In some embodiments, the number of the second fixing members 316 may be 0, 1, 2, 3, or more. The number of the second fixing members 316 may be selected according to parameters such as the length of the cable 3 and distances between the second fixing member 316, the first fixing member 315, the port 219, and the connecting member.

As shown in FIG. 12, in some embodiments, the first fixing member 315 may be arranged on a side of the connecting member close to the port 219 or on a side of the connecting member away from the port 219.

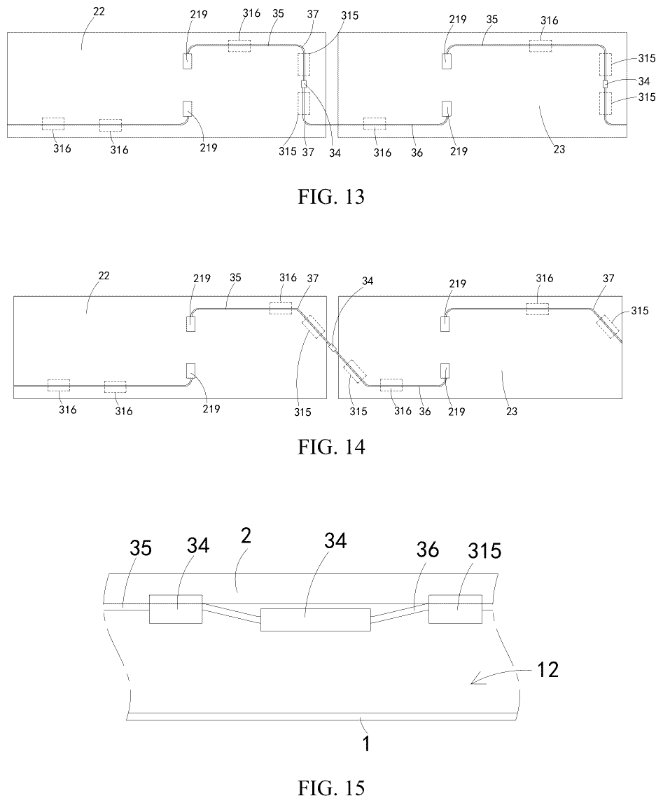

As shown in FIG. 13 and FIG. 14, in some embodiments, the cable 3 of the photovoltaic module 2 includes a first cable 35 and a second cable, and when adjacent photovoltaic modules 2 are connected, the first cable 35 of one photovoltaic module is electrically connected to the second cable of another photovoltaic module. In the first cable 35 and the second cable, one may serve as the positive cable 32 and the other may serve as the negative cable 33. During the connection, the positive cable 32 of the photovoltaic module 2 and the negative cable 33 of another photovoltaic module 2 are electrically connected through the connecting member. Moreover, at least one of the first cable 35 and the second cable connected to each other includes a bending section 37.

The bending section 37 is configured to change the extension direction of the cable 3 so that wiring may have a Z-shaped structure. By adjusting the direction of the cable 3, the connection position of the first cable 35 and the second cable can be adjusted, thereby facilitating the connection between the first cable 35 and the second cable. The cable 3 may be wired in a straight shape, a V shape, a U shape, an S shape, a Z shape, a wave shape, or other shapes. An angle between the extension direction of the cable 3 and the length direction or the width direction of the photovoltaic module 2 is in a range of 0° to 90°.

As shown in FIG. 13, in some embodiments, the wiring of the cable 3 may have a right-angled structure. That is, two parts of the bent cable 3 are perpendicular to each other.

As shown in FIG. 14, in some embodiments, the wiring of the cable 3 may have an obtuse-angled structure. That is, an angle between two parts of the bent cable 3 is an obtuse angle.

As shown in FIG. 13, in some embodiments, the photovoltaic module 2 includes two ports 219, along the width direction of the photovoltaic module 2, the ports 219 are sequentially arranged on the side of the photovoltaic module 2 facing the color steel tile 1, and the first cable 35 and the second cable are connected to the corresponding ports 219 respectively.

Based on the photovoltaic module 2 provided in the above embodiments, the present disclosure further provide a photovoltaic component. The photovoltaic component includes a photovoltaic module 2 and a color steel tile 1. The photovoltaic module 2 is mounted on the color steel tile 1. The photovoltaic component may be mounted at a position such as the roof. The side of the color steel tile 1 facing the photovoltaic module 2 is provided with a cavity 12, and a cable 3 is located on a side of the photovoltaic module 2 facing the color steel tile 1. Along a thickness direction of the photovoltaic module 2, at least part of the cable 3 and at least part of a connecting member are located in the cavity 12, and are at a distance from a bottom wall of the cavity 12. That is, the cable 3 and the connecting member do not hang down on the color steel tile 1, and the cable 3 and the connecting member are not in contact with a bottom wall of the color steel tile 1. The photovoltaic module 2 may be the photovoltaic module 2 as referred to in any one of the above embodiments. Since the photovoltaic module 2 has the above technical effects, the photovoltaic component including the photovoltaic module 2 also has the corresponding technical effects. Details are not described herein again.

The photovoltaic component may be arranged at a position such as the roof of a building to form a rooftop power station to convert received solar energy into electrical energy. The photovoltaic component may include a plurality of color steel tiles 1 and a plurality of photovoltaic modules 2. Adjacent photovoltaic modules 2 are electrically connected through cables 3. The photovoltaic modules 2 may be mounted on, for example, the roof of the building through the color steel tiles 1.

As shown in FIG. 9, in some embodiments, an angle between the first side 211 and the third side 213 is a first angle 215, an angle between the first side 211 and the fourth side 214 is a second angle 216, an angle between the second side 212 and the fourth side 214 is a third angle 217, and an angle between the second side 212 and the third side 213 is a fourth angle 218. The photovoltaic component includes a first photovoltaic module and a second photovoltaic module. The first photovoltaic module and the second photovoltaic module are electrically connected through the cable 3. At least one first fixing member 315 is located on a side where the fourth angle 218 of the first main body portion 22 is located, and at least one first fixing member 315 is located on a side where the first angle 215 of the second main body portion 23 is located. Additionally or alternatively, at least one first fixing member 315 is located on a side where the second angle 216 of the first main body portion 22 is located, and at least one first fixing member 315 is located on a side where the third angle 217 of the second main body portion 23 is located.

As shown in FIG. 15, through such a design, the first cable 35 and the second cable connected to each other can be fixed, thereby reducing the possibility of hanging of the cable 3 and the connecting member down to the color steel tile 1. Moreover, the first cable 35 and the second cable connected to each other are fixed by the first fixing member 315. That is, the cables 3 on two sides of the connecting member are both fixed by the first fixing member 315. Therefore, the load of a single first fixing member 315 can be reduced, thereby improving stability of the first fixing member 315. It is conducive to keeping the cable 3 and the connecting member in a suspended state, reducing the possibility of contact between the two and the color steel tile 1 and also reducing the possibility of shaking of the connecting member and the cable 3, thereby reducing the possibility of an influence on the electrical connection of the photovoltaic module 2 due to detachment of the cables 3 connected to each other from the connecting member due to shaking.

As shown in FIG. 13 and FIG. 14, in some embodiments, along width directions of the photovoltaic modules 2, the first cables 35 of the photovoltaic modules 2 are located on the same side, and the second cables of the photovoltaic modules 2 are located on the same side. During the connection, the cable 3 may be in a Z shape.

This design can make the arrangement directions of the photovoltaic modules 2 uniform, thereby facilitating layout and improving assembly efficiency.

As shown in FIG. 11, in some embodiments, a same set of first cables 35 and second cables for connection in adjacent photovoltaic modules 2 are located on a same side along the width directions of the photovoltaic modules 2. That is, along the arrangement direction of the photovoltaic modules 2, the first cables 35 and the second cables are alternately arranged.

This design can shorten the distance between the first cable 35 and the second cable connected to each other, thereby facilitating the connection between the two and reducing difficulty of wiring.

In actual use, the photovoltaic modules 2 may be arranged according to the actual requirement, thereby adjusting positions of the cables 3 of the adjacent photovoltaic modules 2. The first cable 35 and the second cable for mutual connection may be located on the same side or on different sides.

Some embodiments of the present disclosure provide a photovoltaic module 2 and a photovoltaic component. The photovoltaic module 2 includes a main body portion 21 and a cable 3 arranged on the main body portion 21. A first fixing member 315 is arranged on the main body portion 21 and configured to fix the cable 3. The main body portion 21 includes a first side 211 and a second side 212 arranged opposite to each other along a length direction thereof and a third side 213 and a fourth side 214 arranged opposite to each other along a width direction thereof. Along the length direction of the main body portion 21, a distance between a mounting point of the first fixing member 315 and the first side 211 or the second side 212 is L4, where 0 mm≤L4≤1000 mm. Along the width direction of the main body portion 21, a distance between the mounting point of the first fixing member 315 and the third side 213 or the fourth side 214 is L5, where 0 mm≤L5≤350 mm. Through such a design, the cable 3 may be fixed by the first fixing member 315, thereby reducing the possibility of drooping of the cable 3 down on the color steel tile 1 and reducing the possibility of short circuit due to an influence of soaking of the cable 3 in water on stability of the electrical connection.

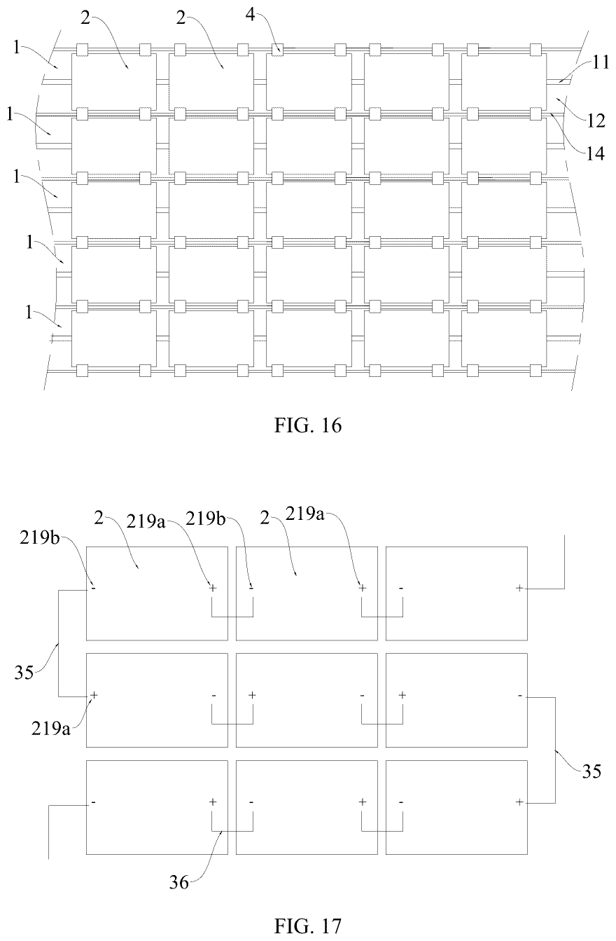

As shown in FIG. 16 and FIG. 17, some embodiments of the present disclosure provide a photovoltaic component, including color steel tiles 1 and photovoltaic modules 2. A plurality of color steel tiles 1 are sequentially arranged along width directions thereof, the color steel tiles 1 are mounted on the ground or a main body of the building through side frames and middle frames, adjacent color steel tiles 1 are connected to each other to form overlocks 14, and clamps 4 are fixed above the overlocks 14. The photovoltaic modules 2 are arranged above the color steel tiles 1. Two ends of the photovoltaic modules 2 are respectively connected to the clamps 4 to fixedly connect the photovoltaic modules 2 to the color steel tiles 1. The main body of the building includes, but is not limited to, roofs and walls of buildings such as production enterprise factories and warehouses. The length direction of the color steel tiles 1 is a first direction, and the width direction of the color steel tiles 1 is a second direction.

Further, the color steel tiles 1 each are provided with a plurality of photovoltaic modules 2 sequentially arranged along the first direction. The photovoltaic modules 2 at two ends are first photovoltaic modules, and the rest are second photovoltaic modules. At least part of the first photovoltaic modules are connected to at least another of the first photovoltaic modules on one side along the second direction. The second photovoltaic modules are sequentially connected to the first photovoltaic modules on at least one side along the first direction. In other words, photovoltaic modules 2 on different color steel tiles 1 can only be connected at end portions of the color steel tiles 1, while photovoltaic modules 2 on a same color steel tile 1 can only be connected inside the color steel tile 1, thereby reducing the number of the cables 3 along the width direction of the color steel tile 1, reducing the risk of damages to the cables 3, and prolonging the service life of the photovoltaic component.

For example, two sides of the first photovoltaic module along the first direction may not be connected to other first photovoltaic modules, thereby forming a free end of a photovoltaic string. The first photovoltaic module is connected to another first photovoltaic module only on one side along the first direction, so that the two first photovoltaic modules are connected to each other. Two sides of the first photovoltaic module along the first direction may be respectively connected to another first photovoltaic module, so that a plurality of first photovoltaic modules are connected to each other.

The photovoltaic modules 2 may be connected through the cable 3. The cable 3 is wrapped in a sealed shell to reduce the risk of damages to, leakage, or short circuit of the cable 3 due to exposure outside the photovoltaic module 2. The cable 3 is located between the photovoltaic module 2 and the color steel tile 1. The cable 3 may be placed on or fixed to the color steel tile 1, or may be fixed to a backlight side of the photovoltaic module 2. The cable 3 may be fixed in any appropriate manner such as adhesive fixation, clamping fixation, or snap-fit fixation. The cable 3 and the photovoltaic module 2 are electrically connected through a plug. Along the height direction of the color steel tile 1, the plug may be located below the photovoltaic module 2, and the plug may alternatively be located in a gap between adjacent photovoltaic modules 2 or below the gap.

For example, along the first direction, the gap between the adjacent photovoltaic modules 2 ranges from 30 mm to 50 mm. For example, the gap may be 30 mm, 32 mm, 35 mm, 38 mm, 40 mm, 42 mm, 45 mm, 48 mm, 50 mm, or the like, preferably 40 mm, which can form an appropriate mounting operation space and can also ensure power generation efficiency of the photovoltaic component. When the gap is less than 30 mm, the mounting operation is inconvenient, which affects assembly efficiency and mounting reliability. When the gap is greater than 50 mm, the gap between the adjacent photovoltaic modules 2 is excessively large, resulting in an excessively small effective power generation area of the photovoltaic component, thereby leading to reduction in the power generation efficiency of the photovoltaic component.

Along the second direction, the gap between the adjacent photovoltaic modules 2 ranges from 42 mm to 62 mm. For example, the gap may be 42 mm, 45 mm, 48 mm, 50 mm, 52 mm, 55 mm, 58 mm, 60 mm, 62 mm, or the like, preferably 52 mm, so that a reliable connection is formed between the photovoltaic module 2 and the clamp 4. When the gap is less than 42 mm, there is a need to reduce the size of the clamp 4, making it difficult for structural strength of the clamp 4 to meet corresponding requirements. When the gap is greater than 62 mm, an actual fitting region between the clamp 4 and the photovoltaic module 2 is smaller, thereby affecting the reliable connection between the photovoltaic module 2 and the clamp 4. The photovoltaic module 2 includes a positive port 219a and a negative port 219b. Two photovoltaic modules 2 are connected to each other by connecting the positive port 219a of one photovoltaic module 2 to the negative port 219b of the other photovoltaic module 2. Along the second direction, the first photovoltaic module is connected to another first photovoltaic module through the first cable 35. In other words, photovoltaic modules 2 on different color steel tiles 1 are connected through the first cable 35. Along the first direction, the second photovoltaic module is connected to the adjacent photovoltaic module 2 (the first photovoltaic module or the second photovoltaic module) through the second cable 36. In other words, adjacent photovoltaic modules 2 on a same color steel tile 1 are connected through the second cable 36.

As shown in FIG. 17, the first cable 35 bypasses an end portion of the color steel tile 1 along the first direction, and the overlock 14 ford not support the first cable 35, so that even if the photovoltaic module 2 is stepped on, relative movement of the photovoltaic module 2 and the overlock 14 along the vertical direction may not cause stress on the first cable 35, thereby further reducing the risk of damages to the cable 3 and prolonging the service life of the photovoltaic component.

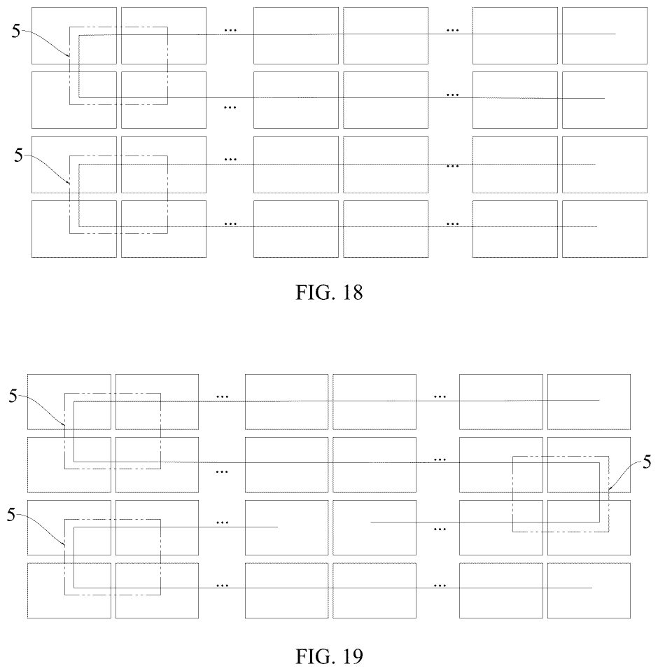

As shown in FIG. 18 to FIG. 23, connection structures between the photovoltaic modules 2 on different color steel tiles 1 may include any one or a combination (including two or more) of a first series-connection structure 5, a second series-connection structure 6, and a third series-connection structure 7.

As shown in FIG. 18 and FIG. 19, in some embodiments, along the second direction, two adjacent first photovoltaic modules are connected to each other, and the two first photovoltaic modules are respectively connected to adjacent second photovoltaic modules along the first direction to form the first series-connection structure 5. The adjacent color steel tiles 1 form a U-shaped connection through the first series-connection structure 5 to realize a short connection distance between the photovoltaic modules 2 on two adjacent color steel tiles 1. If the connection distance is short, an exposed length of the first cable 35 is relatively short, which reduces the risk of damages to the first cable 35 due to exposure. In addition, the short connection distance may also make a usage length of the first cable 35 relatively short, thereby saving materials and reducing manufacturing costs.

Further, a plurality of first series-connection structures 5 are provided at a same end of the color steel tile 1, and the plurality of first series-connection structures 5 are sequentially arranged adjacently along the second direction. Through the plurality of first series-connection structures 5 sequentially arranged adjacently, the connection between the photovoltaic modules 2 at one end of the color steel tile 1 is completed, which are connected in a simple and clear manner and are easy to mount and operate on site. It may be understood that the first series-connection structures 5 may alternatively be arranged at intervals along the second direction.

Further, two ends of the color steel tile 1 are each provided with the plurality of first series-connection structures 5, and the first series-connection structures 5 at the two ends are arranged in a staggered manner to prevent formation of a closed or short-circuited connection between two adjacent color steel tiles 1, thereby reducing possible errors during the mounting. It may be understood that alternatively, one end of the color steel tile 1 is provided with the first series-connection structure 5, and the other end is a free end or the other end is provided with the second series-connection structure 6 or the third series-connection structure 7.

Further, two ends of the first series-connection structure 5 are sequentially connected to another first photovoltaic module along the first direction. In other words, the photovoltaic modules 2 on a same color steel tile 1 are all sequentially connected. During the mounting, the operator does not need to specifically identify the number of photovoltaic modules 2 connected into a string, which further simplifies the mounting operation and makes mounting and connection errors less likely to occur.

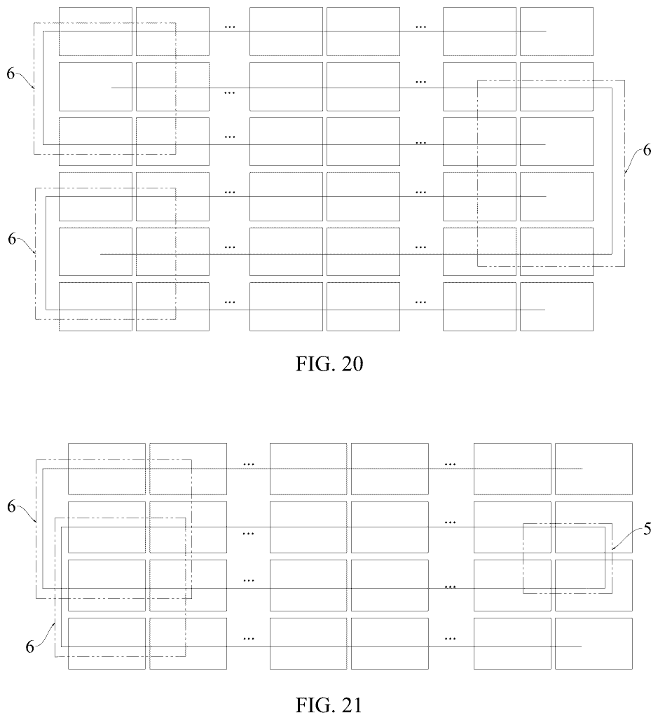

As shown in FIG. 20 and FIG. 21, in some other embodiments, along the second direction, two of the first photovoltaic modules spaced apart from each other are connected to each other, the two first photovoltaic modules may be separated by one or more (including two or more) first photovoltaic modules, and the two first photovoltaic modules are respectively connected to adjacent second photovoltaic modules along the first direction to form the second series-connection structure 6. Through the second series-connection structure 6, color steel tiles 1 not adjacent to each other form a U-shaped connection to realize the connection between the photovoltaic modules 2 on two color steel tiles 1 spaced apart from each other, which can adapt to complex and changeable mounting sites and serial and parallel connection requirements, and the mounting manner is more flexible.

In some embodiments, same ends of the color steel tiles 1 are provided with a plurality of second series-connection structures 6. In some embodiments, the plurality of second series-connection structures 6 are sequentially arranged adjacently along the second direction, and there is no intersection between the cables 3, which are connected in a simple and clear manner and are easy to mount and operate on site. In some other embodiments, the plurality of second series-connection structures 6 are sequentially arranged crosswise along the second direction, so that the same ends of the color steel tiles 1 can complete as many connections of the first photovoltaic modules as possible, simplifying the mounting operation process. It may be understood that the second series-connection structures 6 may alternatively be arranged at intervals along the second direction.

Further, two ends of the color steel tile 1 are each provided with the plurality of second series-connection structures 6, and the second series-connection structures 6 at the two ends are arranged in a staggered manner to prevent formation of a closed or short-circuited connection between two adjacent color steel tiles 1, thereby reducing possible errors during the mounting. It may be understood that alternatively, one end of the color steel tile 1 is provided with the second series-connection structure 6, and the other end is a free end or the other end is provided with the first series-connection structure 5 or the third series-connection structure 7.

Further, two ends of the second series-connection structure 6 are sequentially connected to another first photovoltaic module along the first direction. In other words, the photovoltaic modules 2 on a same color steel tile 1 are all sequentially connected. During the mounting, the operator does not need to specifically identify the number of photovoltaic modules 2 connected into a string, which further simplifies the mounting operation and makes mounting and connection errors less likely to occur.

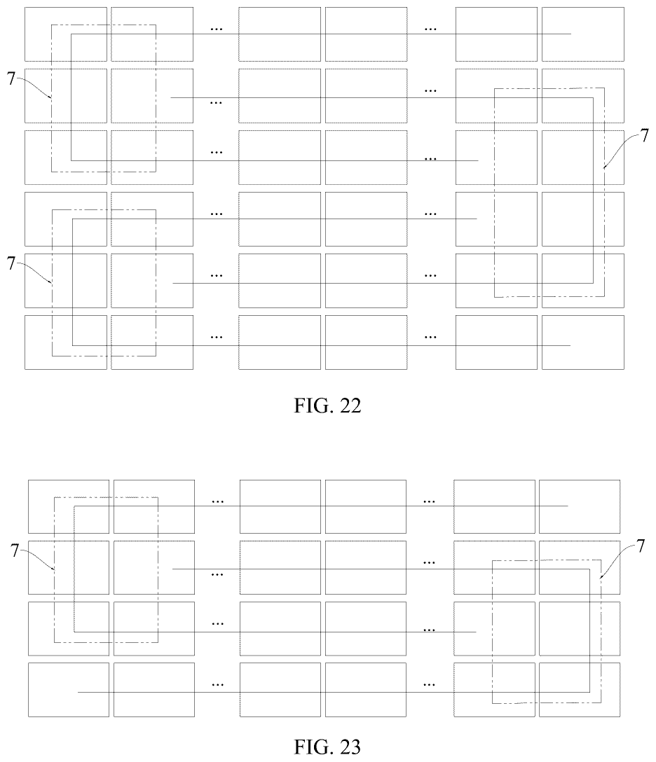

As shown in FIG. 22 and FIG. 23, in some other embodiments, along the second direction, two adjacent first photovoltaic modules are connected to each other, and the two first photovoltaic modules at two ends are respectively connected to adjacent second photovoltaic modules along the first direction to form the third series-connection structure 7. Through the third series-connection structure 7, continuous color steel tiles 1 form a U-shaped connection to realize the connection between the photovoltaic modules 2 on the continuous color steel tiles 1, which can adapt to complex and changeable mounting sites and serial and parallel connection requirements, and the mounting is more flexible.

In some embodiments, same ends of the color steel tiles 1 are provided with a plurality of third series-connection structures 7, and the plurality of third series-connection structures 7 are sequentially arranged adjacently along the second direction, which are connected in a simple and clear manner and are easy to mount and operate on site. It may be understood that the third series-connection structures 7 may alternatively be arranged at intervals along the second direction.

In some embodiments, two ends of the color steel tile 1 are each provided with the plurality of third series-connection structures 7, and the third series-connection structures 7 at the two ends are arranged in a staggered manner to prevent formation of a closed or short-circuited connection between two adjacent color steel tiles 1, thereby reducing possible errors during the mounting. It may be understood that alternatively, one end of the color steel tile 1 is provided with the third series-connection structure 7, and the other end is a free end or the other end is provided with the first series-connection structure 5 or the second series-connection structure 6.

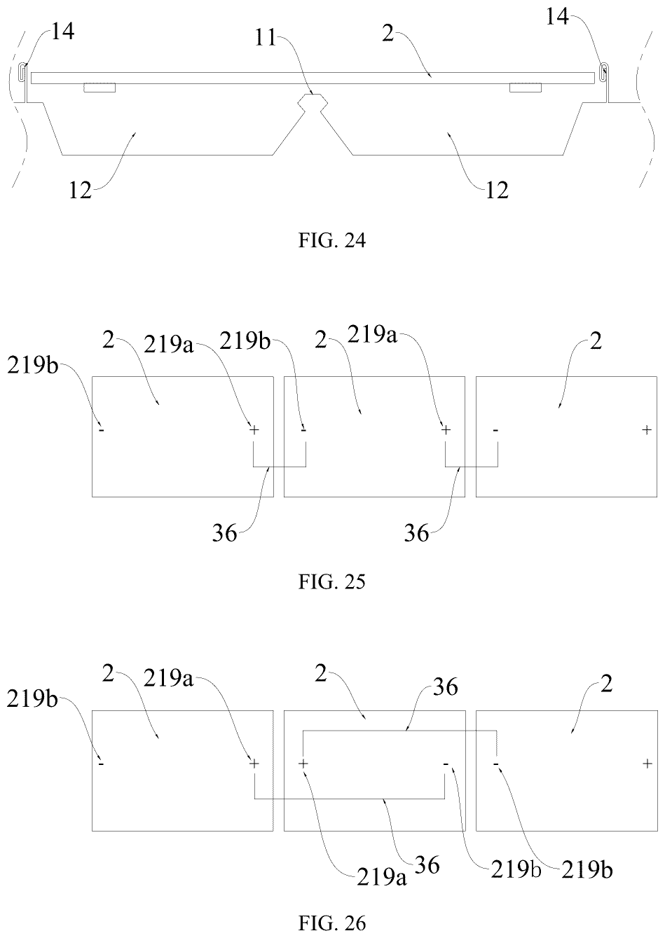

As shown in FIG. 24 to FIG. 27, the color steel tile 1 is provided with a reinforcing portion 11 in the middle, and the reinforcing portion 11 extends along the first direction. One or a plurality of (including two or more) reinforcing portions 11 may be provided. When a plurality of reinforcing portions 11 are provided, the reinforcing portions 11 are arranged at intervals along the second direction. Overlocks 14 are formed between two adjacent color steel tiles 1, and the reinforcing portion 11 divides a space between two adjacent overlocks 14 into at least two cavities 12. For example, the cavity 12 may be formed between the reinforcing portion 11 and the overlock 14, and the cavity 12 may also be formed between two adjacent reinforcing portions 11. The second cable 36 is received in the cavity 12, and an extension direction of the second cable 36 is consistent with that of the cavity 12. The second cable 36 is hidden and protected through the cavity 12, thereby reducing the risk of damages to the second cable 36 due to exposure.

As shown in FIG. 25 and FIG. 26, in some embodiments, the second cables 36 at two ends of a same second photovoltaic module are received in a same cavity 12, so that centralized arrangement and connection of the second cables 36 can be completed in the same cavity 12, thereby improving mounting efficiency. Moreover, the second cables 36 can extend in a straight direction as much as possible, and the second cables 36 are kept in a freely extending state as much as possible, which prevents generation of stress at the contact portion between the second cable 36 and the reinforcing portion 11 caused by crossing of the second cable 36 over the reinforcing portion 11 between adjacent cavities 12.

For example, the positive port 219a and the negative port 219b of the photovoltaic module 2 are arranged along the first direction. In other words, the arrangement direction of the positive port 219a and the negative port 219b is consistent with the extension direction of the cavity 12, so that the port 219a and the negative port 219b are located in a same cavity 12. That is, the second cables 36 at two ends of a same second photovoltaic module are located in a same cavity 12.

In some embodiments, referring to FIG. 25, on a same color steel tile 1, the positive ports 219a and the negative ports 219b of adjacent photovoltaic modules 2 are arranged in a same direction, so that the positive port 219a of one photovoltaic module 2 is close to the negative port 219b of the other adjacent photovoltaic module 2, which can reduce the length of the second cable 36 and can prevent staggering or crossing of the second cables 36, making the mounting operation easier and reducing the possibility of connection errors during the mounting. In other embodiments, referring to FIG. 26, the positive ports 219a and the negative ports 219b of adjacent photovoltaic modules 2 may alternatively be arranged in different directions.

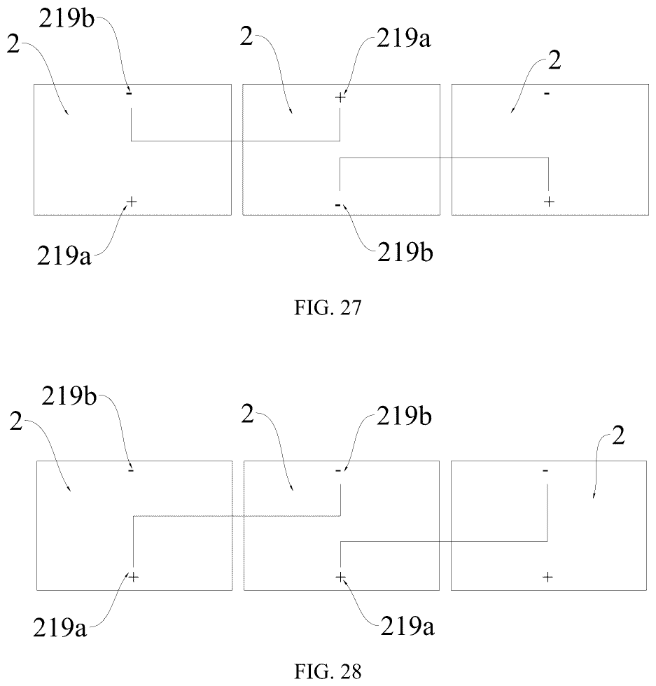

As shown in FIG. 27, in some other embodiments, the second cables 36 at two ends of a same second photovoltaic module are respectively received in two different cavities 12. In other words, the second cables 36 extend along the first direction, and two second cables 36 adjacent along the first direction are staggered from each other along the second direction, forming a reasonable distributed arrangement for the second cables 36, so that distribution of the second cable 36 is clearer, which reduces the possibility of incorrect connection of the cable 3 and can also keep the second cables 36 in a freely extending state as much as possible to prevent generation of stress at the contact portion between the second cable 36 and the reinforcing portion 11 caused by crossing of the second cable 36 over the reinforcing portion 11 between adjacent cavities 12.

For example, the positive port 219a and the negative port 219b are arranged along the second direction. In other words, the arrangement direction of the positive port 219a and the negative port 219b is consistent with that of the cavity 12, so that the positive port 219a and the negative port 219b are located in two different cavities 12. On a same color steel tile 1, the positive ports 219a and the negative ports 219b of two adjacent photovoltaic modules 2 are arranged in opposite directions. In other words, in the two adjacent photovoltaic modules 2, the positive port 219a of one photovoltaic module 2 and the negative port 219b of the other photovoltaic module 2 are located in a same cavity 12. The positive port 219a and the negative port 219b are connected through the second cable 36, so that the second cable 36 is also located in the cavity 12 and extends along the cavity 12.

In some embodiments, along the second direction, the positive ports 219a and the negative ports 219b of two first photovoltaic modules connected to each other are arranged in a same direction, and the two first photovoltaic modules connect ports 219 close to each other through the first cable 35, to reduce the length of the first cable 35 and prevent connection errors caused by crossover of the cables 3. It may be understood that the two first photovoltaic modules may alternatively connect ports 219 away from each other through the first cable 35. In other embodiments, along the second direction, the positive ports 219a and the negative ports 219b of two first photovoltaic modules connected to each other may alternatively be arranged in opposite directions.

As shown in FIG. 24 and FIG. 28, in some other embodiments, the positive port 219a and the negative port 219b are arranged along the second direction, on a same color steel tile 1, the positive ports 219a and the negative ports 219b of two adjacent photovoltaic modules 2 are arranged in a same direction, one part of the second cable 36 is located in one cavity 12 and the other part of the second cable 36 is located in another cavity 12, and a middle part of the second cable 36 crosses the reinforcing portion 11 between the two cavities 12.

The above are merely preferred embodiments of the present disclosure and are not intended to limit the present disclosure. For those skilled in the art, the present disclosure may be subject to various changes and variations. Any modification, equivalent replacement, improvement, and the like made within the spirit and principles of the present disclosure shall fall within the protection scope of the present disclosure.

What is claimed is:

1. A photovoltaic component, comprising:
a plurality of color steel tiles, wherein adjacent color steel tiles of the plurality of color steel tiles are connected to each other along a width direction of the photovoltaic component;
a plurality of photovoltaic modules mounted, along a thickness direction of the photovoltaic component, to a side of the color steel tiles, wherein a plurality of cavities are formed between the photovoltaic modules and the color steel tiles; and
cables each connecting to two adjacent photovoltaic modules, wherein each of the cables is provided with at least one fixing portion configured to fix the cable to a side of the photovoltaic module close to a corresponding one of the color steel tiles, the cables are located in the cavities, and along the thickness direction, the cables and the color steel tiles are not in contact with each other.

2. The photovoltaic component according to claim 1, wherein a distance between the cable and the color steel tile in the thickness direction is H, where 0<H≤200 mm.

3. The photovoltaic component according to claim 2, wherein a gap is formed between adjacent photovoltaic modules, and a width of the gap is L1, where 0<L1≤200 mm.

4. The photovoltaic component according to claim 3, wherein each of the cables comprises a positive cable and a negative cable which are connected to each other through a joint, one of two adjacent photovoltaic modules is connected with the positive cable, the other one of the two adjacent photovoltaic modules is connected with the negative cable, at least one of the positive cable and the negative cable is fixed to the side of the photovoltaic module close to the color steel tile through the fixing portion, and along the thickness direction of the photovoltaic component, a projection of the joint does not overlap with the gap.

5. The photovoltaic component according to claim 4, wherein a distance between the fixing portion and the joint is L2, where 0<L2≤200 mm.

6. The photovoltaic component according to claim 1, wherein when a plurality of fixing portions are provided, a distance between two adjacent fixing portions is L3, and L3≤300 mm.

7. The photovoltaic component according to claim 1, wherein the color steel tiles each include at least one reinforcing portion, the reinforcing portion protrudes towards the photovoltaic module, the cable extends along a length direction of the photovoltaic module, and in the thickness direction of the photovoltaic component, a projection of the cable does not overlap with the reinforcing portion.

8. The photovoltaic component according to claim 1, wherein the photovoltaic modules each include a main body portion, the fixing portion comprises a first fixing member arranged on the main body portion, the main body portion includes a first side and a second side arranged opposite to each other along a length direction of the main body portion and a third side and a fourth side arranged opposite to each other along a width direction of the main body portion, along the length direction of the main body portion, a distance between a mounting point of the first fixing member and the first side or the second side is L4, where 0 mm≤L4≤1000 mm, and along the width direction of the main body portion, a distance between the mounting point of the first fixing member and the third side or the fourth side is L5, where 0 mm≤L5≤350 mm.

9. The photovoltaic component according to claim 8, wherein the main body portion includes a port, the cable is connected to the main body portion through the port, and the first fixing member is configured to fix an end of the cable away from the port; and
the photovoltaic module further includes a second fixing member, along an extension direction of the cable, the second fixing member is located between the port and the first fixing member and is configured to fix the cable.

10. The photovoltaic component according to claim 9, wherein the photovoltaic module includes a plurality of second fixing members, and the second fixing members are distributed at intervals along the extension direction of the cable.

11. The photovoltaic component according to claim 9, wherein a distance between the port and a mounting point of the second fixing portion adjacent to the port is b, where 0 mm≤b≤100 mm.

12. The photovoltaic component according to claim 9, wherein a distance between mounting points of adjacent second fixing members is c, where 0 mm≤c≤100 mm.

13. The photovoltaic component according to claim 8, wherein the cable includes a first cable and a second cable, the first cable of each of the photovoltaic modules is configured to be electrically connected to the second cable of another one of the photovoltaic modules, and at least one of the first cable and the second cable connected to each other includes a bending section.

14. The photovoltaic component according to claim 1, wherein a length direction of the color steel tiles is defined as a first direction, and a width direction of the color steel tiles is defined as a second direction;
a plurality of photovoltaic modules sequentially are arranged along the first direction over the color steel tiles, wherein the photovoltaic modules includes first photovoltaic modules arranged at two outermost ends, and second photovoltaic modules arranged in the middle;
at least part of the first photovoltaic modules are connected to at least another one of the first photovoltaic modules on one side along the second direction; and
the second photovoltaic modules are connected to the first photovoltaic modules on at least one side along the first direction.

15. The photovoltaic component according to claim 14, wherein along the second direction, two adjacent first photovoltaic modules are connected to each other, and the two first photovoltaic modules are respectively connected to adjacent second photovoltaic modules along the first direction to form a first series-connection structure.

16. The photovoltaic component according to claim 15, wherein a same end of the color steel tile is provided with a plurality of first series-connection structures, and the plurality of first series-connection structures are sequentially arranged adjacent to each other along the second direction.

17. The photovoltaic component according to claim 16, wherein two ends of the color steel tile are each provided with a plurality of first series-connection structures, and the first series-connection structures at the two ends are arranged in a staggered manner.

18. The photovoltaic component according to claim 16, wherein two ends of the first series-connection structure are respectively connected to another one of the first photovoltaic modules along the first direction.

19. The photovoltaic component according to claim 14, wherein along the second direction, two of the first photovoltaic modules spaced apart from each other are connected to each other, and the two first photovoltaic modules are respectively connected to adjacent second photovoltaic modules along the first direction.

20. The photovoltaic component according to claim 14, wherein along the second direction, adjacent first photovoltaic modules are sequentially connected to each other, and the two first photovoltaic modules at the two outermost ends are respectively connected to adjacent second photovoltaic modules along the first direction; or
along the second direction, one of the first photovoltaic modules is connected to another one of the first photovoltaic modules through a first cable, and the first cable bypasses an end of the color steel tile along the first direction.
